(19) United States
(12) Patent Application Publication
(10) Pub. No.: US 2022/0080676 A1
(43) Pub. Date: Mar. 17, 2022

(54) SOLUBLE SUPPORT FOR FUSED DEPOSITION MODELING

(71) Applicant: Impossible Objects, Inc., Northbrook, IL (US)

(72) Inventors: Robert Swartz, Highland Park, IL (US); Eugene Gore, Des Plaines, IL (US); Buckley Crist, Wilmette, IL (US)

(73) Assignee: Impossible Objects, Inc., Northbrook, IL (US)

(21) Appl. No.: 17/447,511

(22) Filed: Sep. 13, 2021

Related U.S. Application Data
(60) Provisional application No. 63/077,001, filed on Sep. 11, 2020.

(51) Int. Cl. B29C 64/40; B29C 64/118; B33Y 10/00; B33Y 40/20; B29C 64/35; B33Y 30/00; B29C 64/209

(52) U.S. Cl. CPC B29C 64/40; B29C 64/118; B33Y 10/00; B29K 2067/046; B29C 64/35; B33Y 30/00; B29C 64/209; B33Y 40/20

(57) ABSTRACT

Apparatus, systems and processes embodying supporting material feedstock for making a support structure for overhangs in a three-dimensional object via a multi-nozzle fused deposition modeling printer, wherein the supporting material is polylactic acid, which is soluble in solution causing base-catalyzed alcoholosis.

### CROSS-REFERENCE TO RELATED APPLICATION

This application claims the benefit of priority of U.S. provisional application number 63/077,001, filed 11 Sep. 2020, the contents of which are herein incorporated by reference.

### BACKGROUND OF THE INVENTION

The present invention relates to apparatus, systems, and processes for making three-dimensional objects of a predetermined shape, and more particularly, to apparatus, systems and processes embodying supporting material feedstock for making a support structure for a three-dimensional (3D) object via a multi-nozzle fused deposition modeling (FDM) printer, wherein the supporting material is polylactic acid (PLA), or other suitable polyester which is relatively more soluble in a chosen liquid (e.g., basic alcohol solutions) than the build material.

A major problem in additive manufacturing or 3D printing is the problem of support structures. There are many geometries for additively manufactured 3D objects having overhangs, which need to be supported during the printing of the 3D object. An example of such a geometry is shown in FIG. 1. There are many prior art solutions to this problem; some are partial solutions. For example, in stereolithography, breakaway support structures are used since the fluid cannot support many overhangs. The problem with breakaway supports is that they must be removed by hand, and this difficult and time consuming.

Fused deposition modeling (FDM) is one of the most popular 3D printing methods due to its low-cost hardware and low-cost materials. FDM uses a continuous filament of a thermoplastic material, which is fed through a moving, heated printer extruder head(s) and is deposited on the additively growing three-dimensional object. As mentioned above, frequently geometries of the three-dimensional o bject have overhang portions or overhang geometries which need to be supported during the printing process. Without a support solution, breakaway support must be used which, as with stereolithography, is slow and cumbersome. Prior art examples of apparatus and methods for making three-dimensional objects with a supporting material that is removed by non-mechanical means, e.g., by dissolution or chemical degradation, or that otherwise disclose chemical treatment of materials described herein, include the following.

U.S. Pat. No. 9,827,754 (owned by the assignee hereunder) discloses a sheet-based 3D printing technology called Composite Based Additive Manufacturing (CBAM) that involves deposition of powder onto a sheet, where a later fusing stage causes the powder to combine with sheet fibers as a build material. The '754 patent discusses a hypothetical sheet substrate made of PLA that (in the unfused parts) can be disintegrated using an unspecified mixture of potassium hydroxide and methanol, but this is unrelated to the context of fused deposition modeling. Furthermore, the CBAM process has inherent support since the unfused material acts as support and is removed in post processing.

U.S. Pat. No. 8,227,540 discloses fused deposition modeling involving extruding a base material that is soluble in an alkaline solution. However, the taught base materials do not extrude well, and if left in the nozzle tend to clog. PLA is not named.

U.S. Published Patent App. No. US2020298490 discloses fabrication of metal electrodes, including an etching process that uses a combination of potassium hydroxide and methanol to disintegrate a shell. The shell can be made using fused deposition modeling. Shell material (as a final build material, not a support) may include a cured polymer material, such as polyacrylates, acrylated epoxies, acrylated urethanes, silicones, IP-dip, IP-S, poly(ethylene glycol) diacrylate (PEGDA), penta erythritol triacrylate (PETA), SU-8 or polydimethylsiloxane (PDMS). PLA is not named.

In WO06110031, composite scaffolds for tissue engineering are made, when a hydrogel is extruded into a bath mixture of sodium hydroxide solution and ethanol, followed by immersion in ethanol. This reference is not in the field of 3D printing.

In U.S. Published Patent App. No. US2019211170, 3D parts are made with a supporting material in conjunction with a build material. One disclosed supporting material is PLA, described as soluble in sodium hydroxide solution, but also described as leaving undesirable wastes.

In EP2826814, sacrificial supporting material (including PLA) is described as being printable within a fused deposition modeling operation. The solvent is described as “water or another suitable solvent,” without further detail.

In U.S. Published Patent App. No. US20150035200, a process called “investment molding” is used to create objects (not FDM). PLA is listed as a possible dissolvable supporting material, named to be dissolvable in caustic soda.

In U.S. Published Patent App. No. US2017120523, two types of printers (FDM and STL) were used to print 3D parts. FDM-printed parts were submerged in a 2 percent (weight/volume) sodium hydroxide solution for 4 hours to dissolve the temporary PLA supports.

Accordingly, there is a long felt need for an inexpensive, consumable and quickly-removable supporting material that can be used for forming support structure for 3D objects fabricated via dual-nozzle FDM printers (one that potentially reduces a 4 hour process to about 10 minutes).

### SUMMARY OF THE INVENTION

In one aspect of the present invention, a method of producing a three-dimensional (3D) object having overhang geometries using fused deposition modeling (FDM) includes the following: dispensing a solidfiable modeling material through a first nozzle via a FDM process, wherein said material defines a 3D composite body of the 3D object; dispensing polylactic acid (PLA) through a second nozzle via the FDM process, the PLA defines a 3D support structure underlying overhanging geometries of said object requiring support during the FDM process, wherein the modeling material comprises at least one building thermoplastic of a plurality of thermoplastics insoluble in a basic solution having a pH of about 7 or more, to result in a printed item comprising PLA overhang supports; and subjecting the printed item PLA overhang supports to a liquid that causes base-catalyzed alcoholosis.

In another aspect of the present invention, the method further includes wherein the building thermoplastic is insoluble in the basic solution having a pH of at least about 11, wherein the first nozzle and the second nozzle are separately controlled for temperature, wherein the first nozzle is operated at a first temperature of about 260 degrees Celsius, and wherein the second nozzle is operated at a second temperature of about 160 degrees Celsius, wherein the PLA overhang supports are substantially dissolved in the liquid after residing therein for less than eleven minutes.

In yet another aspect of the present invention, a system for producing a three-dimensional (3D) object requiring support for at least one overhang geometry, includes the following: a first nozzle for selectively dispensing a solidfiable modeling material in accordance with a FDM process, wherein said material defines a 3D composite body of the 3D object; a second nozzle for selectively dispensing a polylactic acid (PLA) in accordance with the FDM process; the PLA defines a 3D support structure underlying at least one overhanging geometry of said object requiring support during the FDM process, wherein the modeling material comprises at least one building thermoplastic of a plurality of thermoplastics insoluble in a basic solution having a pH of about 7 or more; and an immersion pool containing a liquid that causes base-catalyzed alcoholosis of the printed item PLA overhang supports.

In another aspect of the present invention, the system further includes wherein the building thermoplastic excludes polymers derived from lactic acid, wherein the basic solution has a pH of at least about 11, wherein the first nozzle and the second nozzle are separately controlled for temperature, wherein the first nozzle is operated at a first temperature of about 260 degrees Celsius, and wherein the second nozzle is operated at a second temperature of about 160 degrees Celsius, and wherein the PLA is substantially dissolved in the liquid after residing therein for less than eleven minutes.

In another embodiment of the present invention, a method of producing a three-dimensional (3D) object having overhang geometries using fused deposition modeling (FDM), the method includes: dispensing a solidfiable modeling material through a first nozzle via a FDM process, wherein said material defines a 3D composite body of the 3D object; dispensing a polyester through a second nozzle via the FDM process; the polyester defines a 3D support structure underlying overhanging geometries of said object requiring support during the FDM process to result in a printed item comprising polyester overhang supports, wherein the modeling material comprises at least one building thermoplastic of a plurality of thermoplastics insoluble in a basic solution having a pH of about 7 or more;

andsubjecting the printed item polyester overhang supports to a liquid that causes base-catalyzed alcoholosis, wherein the building thermoplastic is insoluble in the basic solution has a pH of at least about 11, wherein the first nozzle and the second nozzle are separately controlled for temperature, wherein the first nozzle is operated at a first temperature of about 260 degrees Celsius, and wherein the second nozzle is operated at a second temperature of about 160 degrees Celsius, wherein the polyester is substantially dissolved in the basic solution after residing therein for less than eleven minutes, wherein the polyester is polylactic acid (PLA) or PET, wherein the liquid comprises alcohol in a greater weight percentage than a base, wherein the base is substantially 5% of the weight percentage of the alcohol, wherein the alcohol comprises methanol or ethanol, and the base comprises potassium hydroxide or sodium hydroxide, wherein the alcohol comprises methanol, and the base comprises potassium hydroxide at substantially 5% of the weight percentage of the methanol, wherein the liquid temperature is substantially 55 degrees Celsius.

In another embodiment of the present invention, a system for producing a three-dimensional (3D) object requiring support for at least one overhang geometry, the system including: a first nozzle for selectively dispensing a solidfiable modeling material in accordance with a FDM process, wherein said material defines a 3D composite body of the 3D object; and a second nozzle for selectively dispensing a polyester in accordance with the FDM process; the PLA defines a 3D support structure underlying at least one overhanging geometry of said object requiring support during the FDM process, wherein the modeling material comprises at least one building thermoplastic of a plurality of thermoplastics insoluble in a basic solution having a pH of 7 or more; and an immersion pool containing a liquid that causes base-catalyzed alcoholosys of the printed item PLA overhang supports, wherein the building thermoplastic excludes polymers derived from lactic acid, wherein the basic solution has a pH of at least about 11, wherein the first nozzle and the second nozzle are separately controlled for temperature, wherein the first nozzle is operated at a first temperature of about 260 degrees Celsius, and wherein the second nozzle is operated at a second temperature of about 160 degrees Celsius, wherein the polyester is substantially dissolved in the basic solution after residing therein for less than eleven minutes, wherein the polyester is polylactic acid (PLA) or PET, wherein the liquid comprises alcohol in a greater weight percentage than a base, wherein the base is substantially 5% of the weight percentage of the alcohol, wherein the alcohol comprises methanol or ethanol, and the base comprises potassium hydroxide or sodium hydroxide, wherein the alcohol comprises methanol, and the base comprises potassium hydroxide at substantially 5% of the weight percentage of the methanol, wherein the liquid temperature is substantially 55 degrees Celsius.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, illustrating a digital three-dimensional model of a three-dimensional object 10 which requires support to be printed with a multi-nozzle FDM printer because of overhang portion/geometries 20.

FIG. 2 is a cutaway perspective view of the model of the three-dimensional object 10 of FIG. 1, illustrating a support structure 30 thereof, wherein the support structure 30 may include a soluble supporting material 50 as distinguished from a modeling material 40 that forms the three-dimensional object 10.

FIG. 3 is a perspective view of the model of FIG. 2, further illustrating the soluble supporting material 50 forming the support structure 30 and the modeling material 40 forming the three-dimensional object 10.

FIG. 4 is a perspective view of an exemplary embodiment of the present invention, illustrating the fabricated three-dimensional object 10 side-by-side as soluble supporting material 50 is being dissolved (or has been dissolved) and after the soluble supporting material 50 has been dissolved presenting the usable three-dimensional object 10.

FIG. 5 is a flow chart of a process of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

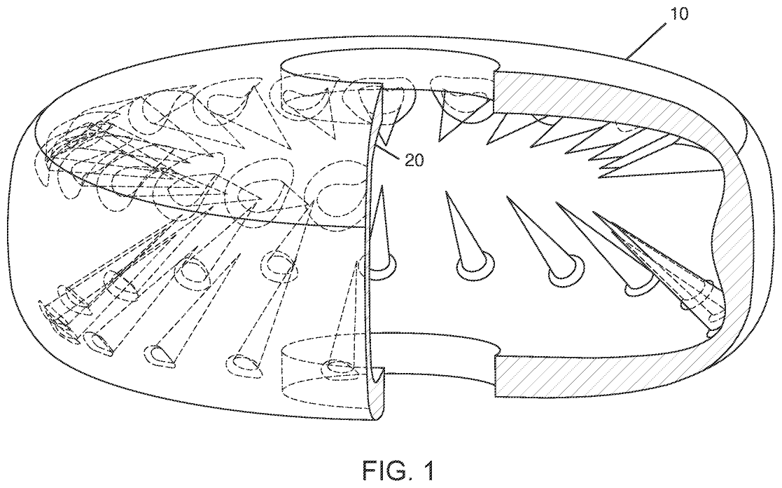

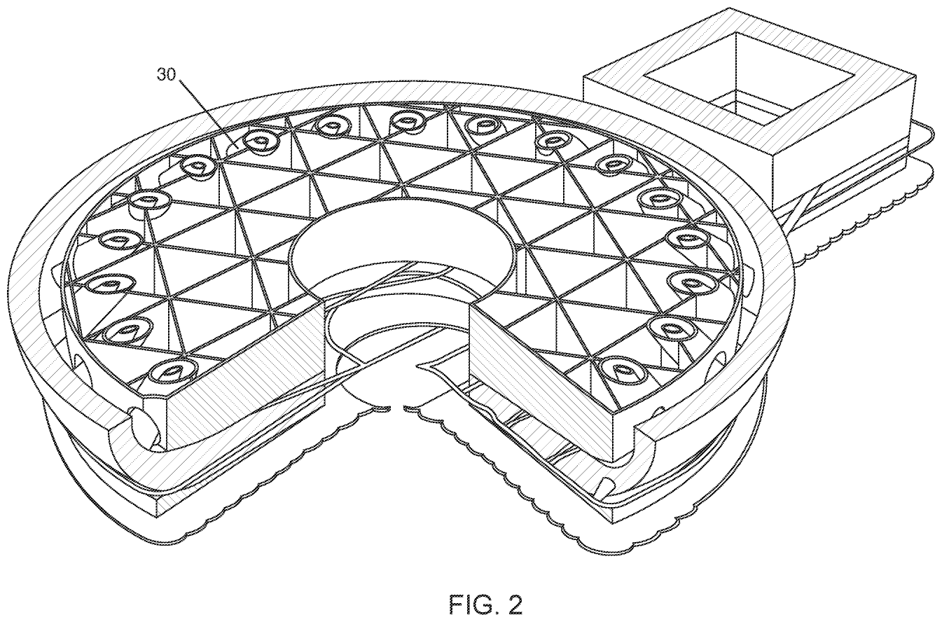

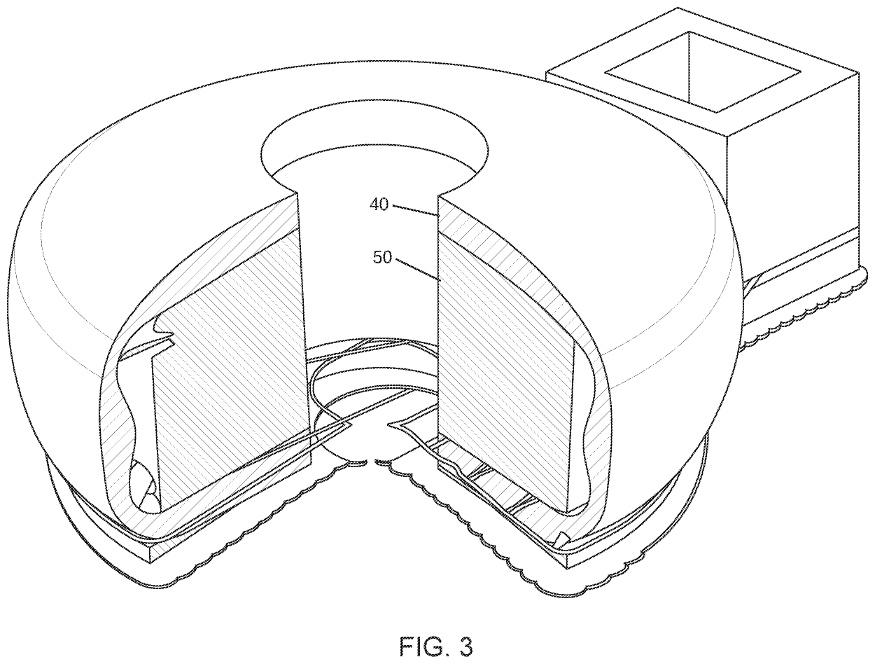

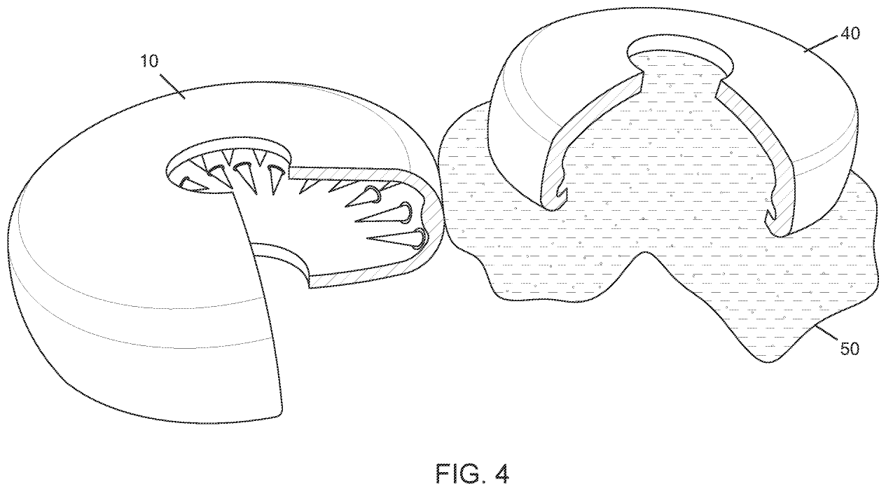

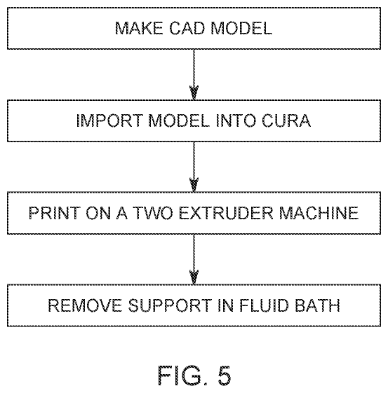

Referring to FIGS. 1 through 5, the present invention relates to an alternate solution to the above-mentioned problems; specifically, apparatus, systems and processes embodying supporting material feedstock for making a support structure for a three-dimensional (3D) object via a multi-nozzle fused deposition modeling (FDM) printer, wherein the supporting material is polylactic acid (PLA), and where means or methods for removing the support material comprise base-catalyzed alcoholosis. PLA is a renewable polymer made from corn that works extremely well in FDM machines and is widely available from a large number of vendors, including but not limited Ahlstrom Chirnsdale Ltd., Chirnsdale, Scotland, U.K., and from C.L. Enterprises, Wenzhou, China.

PLA can be broken down—or is soluble—in an ethanol, methanol, or isopropanol base solution such as methanol and potassium hydroxide, or alternatively sodium hydroxide or ethanol, or possibly hydrochloric acid in aqueous solution. With higher temperatures and longer reside times, in a basic “disintegrator” solution of potassium hydroxide and water, PLA similarly breaks down. The three-dimensional object with PLA supporting material is put into the basic solution “bath”, such as a reaction vessel, which is primarily made of an alcohol (such as methanol or ethanol). Agitation of the bath or ultrasonic methods are applied, until the supporting material is either broken down or dissolved. The agitation can be accomplished by pumping the fluid, or agitation as in a washing machine, among other methods. Ultrasonic tanks can also be used. Disintegration/dissolution of the supporting material can be done at elevated temperatures. It is understood that a variety of techniques may be employed to accelerate dissolution or degradation of the supporting material, for example by agitating and/or heating the disintegrator solution/bath. As non-limiting examples, any of the following may be agitated or heated to speed the dissolution or degradation: agitation achieved by, for example, but not limited to, ultrasound, a magnetic or paddle stirrer, shaking, or jets of liquid. This invention is not limited, however, to the methods of removing the supporting material listed above. Any other removal approach known in the art that relies on a difference between the material properties of the supporting material and the solidified thermoplastic modeling material in the specified solution, causing the former to be more susceptible than the latter to be soluble, may be advantageously employed in the invention.

Solubility characteristics required of PLA are that it be readily soluble in an alcohol, a basic solution (pH 7 or higher), or both, that does not adversely affect the modeling material. As used herein, “soluble” means disintegration of a polymer into smaller chains. As a corollary, a polymer is “soluble in a solution” if the material is substantially dissolvable and/or dispersible into smaller polymeric chains, and a polymer is “insoluble in a solution” if the polymer insubstantially disintegrates into smaller polymeric chains under the above-mentioned temperature, alcohol and pH conditions. The term substantially dissolves is understood to mean wherein at least ninety percent of the backbone chains in those polymers are severed into smaller chains.

After printing a combined object that includes its modeled form plus support material for overhangs, it is necessary to break down the PLA. The (basic) alcohol solution described can be used in addition to any other solution that will break down PLA. In addition, other polymers can be used for support, if there is a chemical method of breaking down the material. This may include as examples any polyester, or any grade of PET, so long as care is taken to match its use as support with a corollary build material of appropriate properties such that the build material will (a) “melt together” with the support out of the nozzles, (b) not dissolve in the support-dissolution liquid, and (c) the support-dissolution liquid itself is matched so as not to dissolve the build material while it dissolves support. In this way, base-catalyzed alcoholosis can advantageously be used with any build material that resists it, along with any support material that succumbs to it.

In this regard, it is well known that semicrystalline polyesters can be degraded by hydrolysis under acidic or basic conditions. Polylactic acid (a polyester) is known to be hydrolyzed more rapidly than poly(ethylene terephthalate).

A property of polyesters is that basic degradation occurs much faster in alcohols than in water, and the rate varies depending on the alcohol used as a solvent. Degradation occurs faster at higher temperatures and higher base (KOH) concentrations. This reaction is base-catalyzed alcoholosis (by analogy to hydrolysis) of the polyester.

Notably, degradation occurs when the reacting liquid or solution is absorbed into the outer regions of the solid polymer near the solid-liquid interface. Backbone chains in those polymers near the surface are severed multiply at random positions, forming many small chains. With sufficient time and/or agitation, these reaction products are removed and new surface is exposed for further degradation. The polymer solid thus becomes smaller with increasing time until it is broken up by flow fields in the liquid phase, disappearing completely. This absorption, subsequent degradation reaction and transport occur almost exclusively in the noncrystalline regions between the polymer nanocrystals; hence a polymer that is more crystalline will degrade more slowly and less completely.

A large surface to volume ratio will favor rapid degradation of a solid polymer. The supporting material in FDM is best printed as an open lattice or scaffold to facilitate removal. Such geometric rate control is used in combination with different chemical degradation rates to selectively achieve the desired result.

The relative chemical degradation rates of candidate polymers for the part and the support are readily evaluated by measuring mass loss of filaments under standard conditions (alcohol, KOH concentration, temperature and agitation).

Again referring to FIGS. 1 through 5, a mode of practicing the present invention includes the following embodiment. The initial extrusion of the modeling material and the supporting material may be done via a FDM printer (including but not limited to a Ultimaker™ 3 Extended 3D Printer) with dual extruders and/or multi-nozzles. One extruder/nozzle can build the part with nylon or ABS or other polymers not reactive or insoluble to basic or alcohol solutions, and the second extruder can use PLA as the supporting material. Moreover, using the known slicing applications for 3D printers (including but not limited to Cura™ software) provided with the FDM printer, a part can be designed with support and then sliced and built. After the part is printed, it can be placed in a solution of potassium hydroxide or sodium hydroxide with an alcohol or similar solution and agitated or placed in an ultrasonic bath. The PLA breaks down quickly leaving the finished part. A basic solution using only potassium hydroxide and water may also be used. As an example, parts shown in the accompanying figures can be built which have overhang portions/geometries, wherein these parts cannot be built without support structures.

As long as the two nozzle temperatures of the head(s) is/are at appropriate temperatures, many materials can be used as modeling materials including: polyester, ABS, nylon, polycarbonate, polypropylene, polyethylene, TPU and Ultem among others. One of the other important aspects of making a support for FDM is the melting temperature of the both the model material and the supporting material. The two temperatures need to be close so that they stick together. One way of accomplishing this is by using block copolymers or blends such as ABS and PLA to control the support melting temperature.

### EXAMPLE: TWO-NOZZLE FDA PRINTING WITH PLA AS THE SUPPORT MATERIAL FEEDSTOCK

The polylactic acid (PLA) feedstock/consumable in the form of 2.85 mm filament/fiber was operatively associated with a first nozzle of a multi-nozzle MFD 3D printer, the Ultimaker™ 3 Extended 3D Printer (“Ultimaker 3”). The Ultimaker 3 has two nozzles on the same print head that can be separately controlled for temperature. A modeling material of polyamide (PA) (a copolymer of PA6 and PA66 obtained from Ultimaker™) was operatively associated with a second nozzle of the Ultimaker 3.

FDM printing of a complex shell was done by the Ultimaker 3 operated at 260 degrees Celsius for the PA (modeling material 40) and 160 degrees Celsius for PLA (supporting material 50). Then said shell and support structure (25 mm high, 70 mm diameter) was immersed in a basic “disintegrator” solution. Here, the disintegrator solution included potassium hydroxide (KOH) dissolved in methanol at 55 degrees Celsius; specifically, 300 mL of methanol containing an amount of about 5% KOH by weight (e.g., mg or pound) of the total disintegrator solution, i.e., about 1 mole KOH for each liter of disintegrator solution, resulting in a pH of more than 11.

With agitation (supplied by an Elma Ultrasonic™ EP10H) the PLA/supporting material was dissolved in 10 minutes by the property of base-catalyzed alcoholosis, leaving the PA shell unaffected by the methanol/KOH disintegrator solution.

Observations of the above Example: The used reaction mixture can be used to remove PLA from additional parts. Alternatively, small solid particles that remain in the reaction vessel may readily be removed by decanting or filtering, after which the methanol can be distilled and reused. PLA filaments from different suppliers may degrade at appreciably different rates. Vinyl polymers should be fine as build/modeling material as they are unreactive in basic alcohol. Polyamides and other polyesters are hydrolyzed under basic conditions, as are polyurethanes. One must consider degradation kinetics of build materials. In this example, PLA support was removed before the PA structure was affected.

As used in this application, the term “about” or “approximately” refers to a range of values within plus or minus 10% of the specified number. And the term “substantially” refers to up to 90% or more of an entirety.

It should be understood, of course, that the foregoing relates to exemplary embodiments of the invention and that modifications may be made without departing from the spirit and scope of the invention as set forth in the following claims.

What is claimed is:

1. A method of producing a three-dimensional (3D) object having overhang geometries using fused deposition modeling (FDM), the method comprising:
dispensing a solidfiable modeling material through a first nozzle via a FDM process, wherein said material defines a 3D composite body of the 3D object;
dispensing a polyester through a second nozzle via the FDM process; the polyester defines a 3D support structure underlying overhanging geometries of said object requiring support during the FDM process to result in a printed item comprising polyester overhang supports,
wherein the modeling material comprises at least one building thermoplastic of a plurality of thermoplastics insoluble in a basic solution having a pH of about 7 or more; and
subjecting the printed item polyester overhang supports to a liquid that causes base-catalyzed alcoholosis.

2. The method of claim 1, wherein the building thermoplastic is insoluble in the basic solution has a pH of at least about 11.

3. The method of claim 2, wherein the first nozzle and the second nozzle are separately controlled for temperature.

4. The method of claim 3, wherein the first nozzle is operated at a first temperature of about 260 degrees Celsius, and wherein the second nozzle is operated at a second temperature of about 160 degrees Celsius.

5. The method of claim 1, wherein the polyester is substantially dissolved in the basic solution after residing therein for less than eleven minutes.

6. The method of claim 1, wherein the polyester is polylactic acid (PLA).

7. The method of claim 1, wherein the polyester is PET.

8. The method of claim 1, wherein the liquid comprises alcohol in a greater weight percentage than a base.

9. The method of claim 8, wherein the base is substantially 5% of the weight percentage of the alcohol.

10. The method of claim 8, wherein the alcohol comprises methanol or ethanol, and the base comprises potassium hydroxide or sodium hydroxide.

11. The method of claim 10, wherein the alcohol comprises methanol, and the base comprises potassium hydroxide at substantially 5% of the weight percentage of the methanol.

12. The method of claim 11, wherein the liquid temperature is substantially 55 degrees Celsius.

13. A system for producing a three-dimensional (3D) object requiring support for at least one overhang geometry, the system comprising:
a first nozzle for selectively dispensing a solidfiable modeling material in accordance with a FDM process, wherein said material defines a 3D composite body of the 3D object;
a second nozzle for selectively dispensing a polyester in accordance with the FDM process; the PLA defines a 3D support structure underlying at least one overhanging geometry of said object requiring support during the FDM process,
wherein the modeling material comprises at least one building thermoplastic of a plurality of thermoplastics insoluble in a basic solution having a pH of 7 or more; and
an immersion pool containing a liquid that causes base-catalyzed alcoholosys of the printed item PLA overhang supports.

14. The system of claim 13, wherein the building thermoplastic excludes polymers derived from lactic acid.

15. The system of claim 14, wherein the basic solution has a pH of at least about 11.

16. The system of claim 13, wherein the first nozzle and the second nozzle are separately controlled for temperature.

17. The system of claim 16, wherein the first nozzle is operated at a first temperature of about 260 degrees Celsius, and wherein the second nozzle is operated at a second temperature of about 160 degrees Celsius.

18. The system of claim 14, wherein the polyester is substantially dissolved in the basic solution after residing therein for less than eleven minutes.

19. The system of claim 13, wherein the polyester is polylactic acid (PLA).

20. The system of claim 13, wherein the polyester is PET.

21. The system of claim 13, wherein the liquid comprises alcohol in a greater weight percentage than a base.

22. The system of claim 21, wherein the base is substantially 5% of the weight percentage of the alcohol.

23. The system of claim 22, wherein the alcohol comprises methanol or ethanol, and the base comprises potassium hydroxide or sodium hydroxide.

24. The system of claim 23, wherein the alcohol comprises methanol, and the base comprises potassium hydroxide at substantially 5% of the weight percentage of the methanol.

25. The system of claim 24, wherein the liquid temperature is substantially 55 degrees Celsius.
